(19) United States
(12) Patent Application Publication
(10) Pub. No.: US 2026/0092491 A1
(43) Pub. Date: Apr. 2, 2026

(54) OUTSWING CASEMENT SYSTEM

(71) Applicant: BBG, S.A., Esposende (PT)

(72) Inventors: Miguel SOUSA ARAÚJO, Esposende (PT); Duarte João ALVES PAULO, Caminha (PT)

(73) Assignee: BBG, S.A., Esposende (PT)

(21) Appl. No.: 19/344,888

(22) Filed: Sep. 30, 2025

(30) Foreign Application Priority Data
Oct. 2, 2024 (PT) 119744

(51) Int. Cl. E06B 3/36; E05C 9/00

(52) U.S. Cl. CPC E06B 3/36; E05C 9/008

(57) ABSTRACT

An outswing casement system incorporating two sets of independent channels, which maximizes the frame (window/door) span, thus enabling large, minimalist outswing casement systems. The first set of channels, external channels, is responsible for the rotation of the vent/leaf or vents/leaves and water drainage. It is designed to position all rotation elements, such as hinges, while simultaneously draining infiltration water. The second set of channels, internal channels, is dedicated to closing the fixed frame and vent between one or two vents, this channel houses all the hardware that allows the system to be closed, such as closing elements. The present invention ensures optimal comfort, safety, and maneuverability of the frame system.

### TECHNICAL FIELD

The present invention belongs to the technical field of frame system, windows, doors and/or gates, especially outswing casement system, and especially minimalist and large-sized outswing casement systems. Large frame systems are those with dimensions equal to or greater than 1400×2800 mm (Width×Height) (L×H).

### BACKGROUND

Outswing casement system are extensively used in most countries with Anglo-Saxon influence, such as the United States of America, Canada, Australia, and New Zealand, as well as in Commonwealth countries, where English construction technology predominates. These systems are also frequently used in areas highly exposed to extreme atmospheric pressures or affected by extreme weather events, such as hurricanes, where high-strength technical requirements must be met. Therefore, these systems are becoming more prevalent in some areas of the world, to the detriment of inward-opening systems common in Europe. Existing state-of-the-art outswing casement systems use only a single set of positioning channels (FIG. 1), which house both the elements for closing and opening, as well as the kinetic elements for operating the window, i.e., its rotation. The open leaf is positioned using an articulated arm mechanism, ensuring that the leaf can be moved comfortably even when projecting outside the facade. In general, these window frame systems use very restrictive accessories regarding leaf weight. They essentially use friction stays (maximum weight 100 kg) with notable dimensional limitations. These systems use these same friction stays as a closing mechanism and leaf travel limiter, which have a stopper lock on the leaf, preventing the stays from moving. These stays, in turn, prevent the use of perimeter multipoint latches, making it impossible to install return angles that allow closing on the crossbar of the movable leaf lintel, since the channel is occupied by the stays.

The term leaf is used in door frames and the term vent is used in window frames.

### SUMMARY

Outswing casement systems with a single set of positioning channels present several problems:
limited maneuverability for weights exceeding 100 kg of glass mass per vent/leaf and for spans exceeding 900 mm in width and 1200 mm in height;
predominance of a single vent/leaf with severe dimensional limitations when opening outswing, which also restricts the use of living space in the residential segment;
impossibility of redirecting movement, not guaranteeing perimeter closure of the vent/leaf. This is particularly debilitating in areas affected by cyclonic pressure phenomena exceeding 1000 Pa, since in positive pressures, the vent/leaf's structural deformation debilitates both the safety of the devices and the watertightness and air permeability characteristics;
application of more energy-efficient triple glazing, which increases the glass mass of the vent/leaf, will make it difficult to find mechanically stable solutions using frictional stays.

The high-inertia Outswing casement system, which is the subject of this invention, can solve the aforementioned technical problems, as it comprises two sets of independent and dedicated channels, each with a distinguish function:
a first set of channels, exterior channels (1), responsible for vent/leaf rotation and water drainage. This set is located in the exterior half-profile of both the fixed frame (6) and the vent/leaf, and is designed to position all the elements that execute the vent/leaf rotation, leading to its opening and closing. Additionally, these exterior channels (1) drain infiltration water;
a second set of channels, interior channels (2), for multipoint perimeter security locking. This set is located in the interior half-profile of both the fixed frame (6) and the vent/leaf, and receives all the elements that allow the window system to close.

Since the second set of channels (2) is dedicated to closing between the fixed frame (6) and the vent/leaf or between two vent/leaf, it is possible to ensure the connection through closing points around the entire perimeter of each vent/leaf, since the set of internal channels (2) is free along the entire external perimeter of the vent/leaf, with this part of the vent/leaf dedicated to rotation, that is, to the set of external channels (1). The multipoint closing mechanism is perimeter and compatible with frictional stays, with a developing return angle.

The advantages of this solution are numerous:
D Resistant to positive and negative pressures exceeding 1000 Pa;
High anti-intrusion resistance, since the set of channels responsible for closing is internal and therefore protected against intrusion attempts due to impact on the closing system;
Ensures the execution under high mechanical resistance conditions of outswing casement operating vents/leaves with a glass area of up to 6m2 per vent/leaf and the maneuverability under safe conditions of vents/leaves with glass masses of up to 180 kg;
allows immediate installation of a rotating cremone handle on the moving vent/leaf (or fixed frame), reducing the operating effort, even on two Outswing casement vent/leaves;
frame rigidity provides remarkable results even under higher positive and negative pressures;
exclusive multipoint hardware compatible with manual movement of the frame using a crank supported by frictional stays;
by maximizing the glass area in the opening, the invention contributes to better energy performance, as well as better acoustic performance, as the glass area will be larger;
increasing the light span in the construction appears to be a contribution to increasing the building's energy efficiency levels;
adding performance even in non-standard construction dimensions and ensuring high resistance even under extreme atmospheric pressures.

### BRIEF DESCRIPTION OF FIGURES

FIG. 1—This figure represents the prior art, which shows only one channel. This figure was taken from patent document GB2560407. This figure shows that the channel (ET) contains frictional stays located on the inner edge of the vent/leaf, allowing its rotation. It also contains the closing point, with a handle, and other elements along the perimeter, preventing the rotation of the closure from being independent.

FIG. 2—A cross-section of the present invention, showing the two sets of channels, which are verified as independent. The set of interior channels (2), which will support the closing elements, is located inside the vent/leaf, that is, on the inside of the fixed frame (6) of the window frame and the perimeter frame (7) of the vent/leaf, and consequently, on the inside of a building. The set of external channels (1), which will support rotation elements, is located on the outside of the fixed frame (6) of the window frame and the perimeter frame (7) of the vent/leaf, and consequently on the inside of a building.

FIG. 3—A cross-section of the present invention, showing the sets of internal channels (2) and external channels (1), where closure elements (3) with a handle are housed within the set of internal channels (2).

FIG. 4—A cross-section of the present invention, showing the sets of internal channels (2) and external channels (1), where rotation elements (4), in this case visible hinges, are housed within the set of external channels (1).

FIG. 5—A cross-section of the present invention, in this case showing the embodiment with two vents (5), in which the closure is performed between them. The set of external channels (1) housing the rotation elements (4), in this case visible hinges, and the sets of internal channels (2) housing the closing elements (3) with handles are shown.

FIG. 6—Vertical sectional representation of the embodiment shown in FIG. 5.

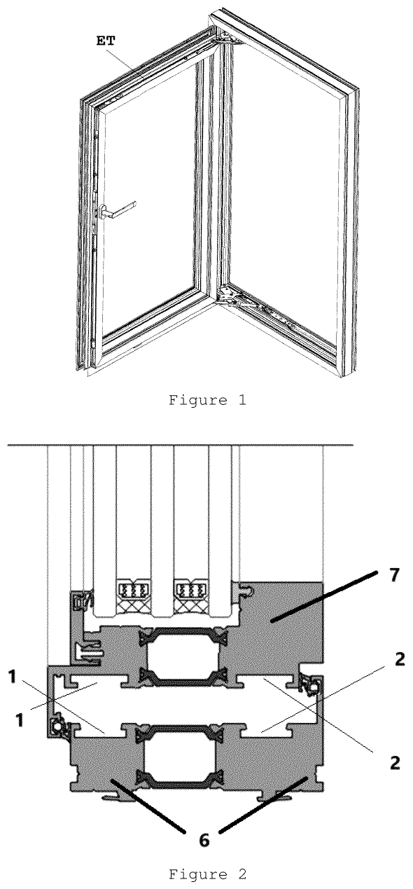

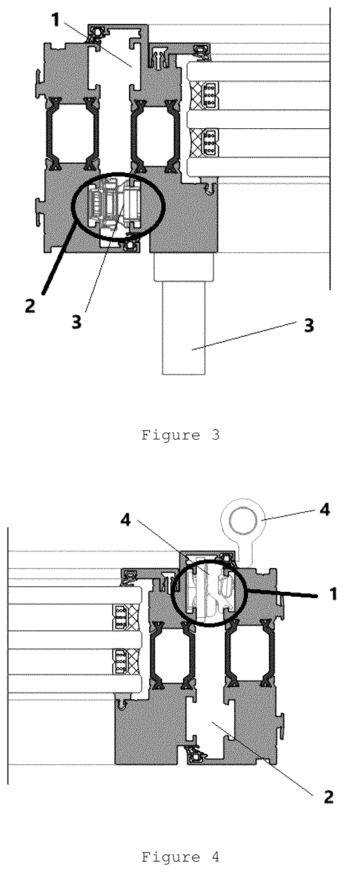

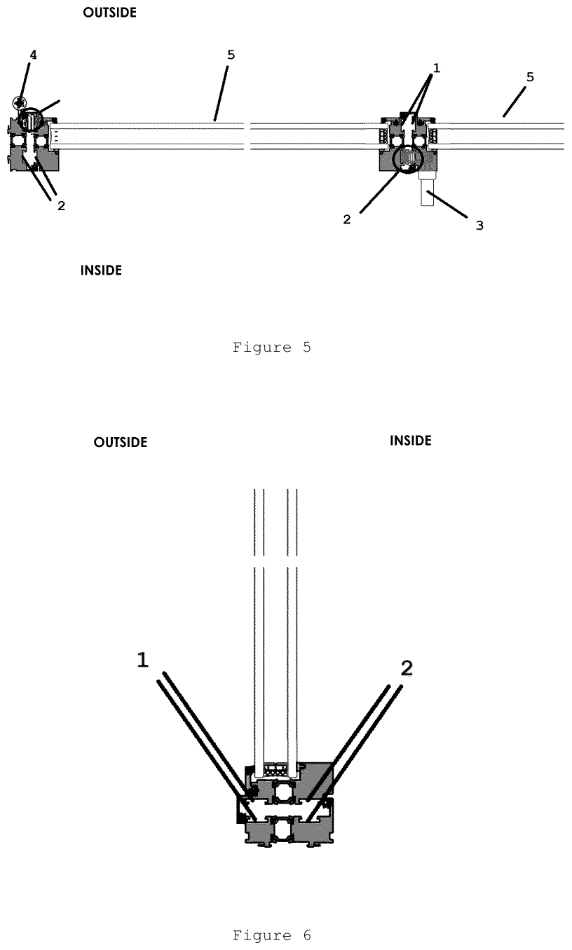

### DETAILED DESCRIPTION OF THE EMBODIMENTS

The present invention relates to an Outswing casement system, for windows/doors/gates, that incorporates two sets of independent channels, which maximizes the window/door span. These sets of channels have distinct functions and achieve different, yet complementary effects.

The first set of channels consists of two exterior channels (1), responsible for the rotation of the vent/leaf or vents/leaves (5) and water drainage. These exterior channels (1) are located in the exterior half-profiles, that is, in the outward/outswing-facing area of both the fixed frame (6) and the perimeter frame (7) of the vent/leaf or vents/leaves. These channels were designed to position all rotation elements, such as hinges (4), and simultaneously drain infiltration water. Therefore, this set of channels receives all the hardware lines for European-style channels, namely the visible hinges (4) or hidden hinges, which allow the vents/leaves (5) to rotate.

The second set of channels consists of two interior channels (2) and is used for closing between the fixed frame (6) and the leaf/vent (5) or between two leaves/vents (5). These two internal channels (2) are located in the internal half-profiles, that is, in the area facing the interior, either in the fixed frame (6) or in the perimeter frame (7) of the leaf/vent (5) or leaves/vents (5). This set of internal channels (2) houses all the hardware that allows the system to be closed. This ensures the connection through closing points around the entire perimeter of each leaf, as this channel is free along the entire external perimeter of the leaf. That is, it does not have any hinges or elements responsible for the movement of the leaves, but rather closing elements (3).

It is worth noting that this approach allows for very small profile views, minimal views. Since one set of channels has only certain elements, and another set has distinct elements, the width of the fixed frame (6) and the perimeter frame (7) of the vent/leaf increases, but their thickness can be reduced. Furthermore, by having a set of channels dedicated to movement, we can increase the number of elements that allow for this rotation, which reinforces the vent/leaf assembly, allowing for its size to be increased. This would be a significant challenge with one or two stays, as they are not sufficiently robust.

In a preferred embodiment of the invention, the frame system comprises a rotating cremone (not shown) with a reduction in the operating force located in the first set, that is, in the exterior channels (1), of the fixed frame (6) and perimeter frame (7) of the vent/leaf.

In a preferred embodiment of the invention, the frame system comprises a safety accessory located in the second set, that is, in the interior channels (2), this accessory (not shown) preventing the opening of the leaf(es) from a certain angle.

It is noted that the elements that allow closing the opening may be closing points, return angles, second leaf ends and latches, and connectors including the polyamide or aluminum cremone bar. In particular, it is a multipoint closing mechanism compatible with frictional stays and return angles.

1. An outswing casement system comprising:
a fixed frame, and
at least one vent/leaf with a perimeter frame, the outswing casement system comprising two sets of independent channels:
a. a first set of channels comprising two exterior channels, these exterior channels are located in the exterior half-profiles of both the fixed frame and the perimeter frame of the at least one movable leaf/vent;
b. a second set of channels comprising two interior channels, these interior channels are located in the interior half-profiles of both the fixed frame and the perimeter frame of the at least one movable leaf/vent.

2. The system according to claim 1, further comprising rotation elements located in the exterior channels allowing the rotation of the at least one movable leaf/vent.

3. The system according to claim 1, further comprising closing elements located in the interior channels that close the frame system either between the fixed frame and the perimeter frame of at least one movable leaf/vent, or between two perimeter frames of two movable leaves/vents.

4. The system according to claim 2, wherein the rotation elements are visible hinges or hidden hinges.

5. The system according to claim 3, wherein the closing elements are closing points, return angles, second leaf ends and locks, connectors, and/or a polyamide or aluminum cremone bar.

6. The system according to claim 3, wherein the closing elements are a multipoint perimeter closing mechanism compatible with a frictional stay and a return angle.

7. The system according to claim 1, further comprising a rotating cremone with reduced operating effort located in the exterior channels.

8. The system according to claim 1, further comprising a safety accessory located in the interior channels limiting the opening of the vent/leaf(s) to a specific angle.
